(19) United States
(12) Patent Application Publication
(10) Pub. No.: US 2011/0168100 A1
(43) Pub. Date: Jul. 14, 2011

(54) Method of feeding aquatic organisms

(76) Inventor: Ingmar Hogoy, Storebo (NO)

(21) Appl. No.: 12/794,805

(22) Filed: Jun. 7, 2010

Related U.S. Application Data
(62) Division of application No. 10/486,389, filed on Jun. 28, 2004, now abandoned.
(60) Provisional application No. 60/309,518, filed on Aug. 3, 2001.

(51) Int. Cl. A01K 61/02; A23K 1/16; A23K 1/18

(52) U.S. Cl. 119/51.04; 426/281

(57) ABSTRACT

A method of feeding aquatic organisms with an artificial food. The food is in the form of microcapsules having an outer permeable polymeric shell of chitosan or alginate and an inner core of liquid food for the aquatic organism. The method involves introducing the microcapsules into an aquatic environment where they are available to be consumed by the organism. The shells of the microcapsules consist of a single polymer, the liquid food has a dry matter content comprising water-soluble, hydrolyzed proteins, peptides and amino acids, and the capsules are arranged to leak the liquid food into the aquatic environment through the shell such that at least 40% of the dry matter content remains in the capsules once the leakage has substantially ceased.

### CROSS REFERENCE TO RELATED APPLICATIONS

This application is a divisional of application Ser. No. 10/486,389 filed 3 Feb., 2004, the entire contents of which are hereby incorporated by reference, said application being a US National Stage application of PCT/GB02/03567 filed 2 Aug. 2002, and claims the benefit under 35 USG §119 of U.S. provisional application 60/309,518 filed 3 Aug., 2001.

### FIELD OF THE INVENTION

The present application relates to feed for aquatic organisms, more specifically to a method for feeding an aquatic organism with an artificial fish food comprising nutrients encapsulated in a microcapsule.

### BACKGROUND

It is known to feed aquatic organisms with a feed comprising so-called “complex” microcapsules. Such microcapsules comprise an inner capsule embedded in an outer layer or capsule of a different material. Such technique is known from, inter alia, WO/87/01587 to Hayward. Hayward discloses a complex liposome microcapsule. The microcapsule has an inner liposome capsule that is encapsulated in an outer capsule made of a hydrocolloid matrix that can comprise alginate. The inner liposome microcapsule encloses a payload that according to Hayward may be a water-soluble nutrient. According to Hayward it is not possible to simply encapsulate the nutrients in the alginate capsule directly, it is a necessary requirement to enclose the water-soluble nutrient inside the inner liposome microcapsule. Hayward states at page 5, line 3 that “Due to their high permeability, [alginate] capsules cannot be used to encapsulate water-soluble components in solution (eg vitamins, amino acids, enzymes, etc).” This extra step of first enclosing the payload in the inner liposome microcapsule is a very complicated, cost-increasing step however.

Hayward in fact expresses a well known prejudice in the art, namely that alginate microcapsules are unsuitable as a feed for fish larvae do to the belief that such capsules leak the nutrient payload at too high a rate.

Another example of known microcapsule feed is disclosed by Chu (U.S. Pat. No. 5,776,490). Chu discloses a complex protein-walled capsule containing an inner lipid walled capsule, and confirms the prejudice held in the art against using alginate microcapsules as feed for larvae. Chu discusses Ca-alginate microcapsules and acknowledges that they are capable of retaining bulk nutrients, but asserts at column 1, line 50 et seq that such microcapsules leak the nutrients at too high a rate to be useful as a food for larvae, and that alginate capsule are not accepted by the larvae stating, “[E]xhaustive trials by the inventors of this patent application have shown that the acceptability of complex alginate microcapsules by striped bass larvae was extremely low”. Chu therefore teaches a complex microcapsule comprising a microcapsule enclosed with an outer, cross-linked protein-walled microcapsule.

Contrary to the belief in the art, the present applicant has demonstrated that a microcapsule, consisting a single polymer such as alginate or chitosan, can be effective used as a feed for fish larvae and that the release rate can be effectively controlled, thus avoiding expense and difficulty of manufacturing complex microcapsules.

The present invention relates to encapsulation of a product, and concerns in particular an encapsulated feed for fish larvae and other aquatic organisms such as bivalves, shellfish and microorganisms.

The natural food sources for a fish larva are mainly based on different species of zooplankton and to some extent phytoplankton. In, for example, Norwegian waters the zooplankton species Calanus finmarcicus and a variety of species of copepods play a major role as live food for commercially-important fish species such as cod, herring and mackerel.

In the aquaculture industry much effort is put into cultivating different marine fish species. Most marine species—halibut, turbot, cod, seabass, seabream and prawns, for example—depend on live food in their first period of feeding. In the first period after hatching, the larvae are getting nutrition from the yolk sac. To avoid starvation the larvae have to start exogenous feeding before the yolk sac is empty. Fish larvae are very small and primitive at first feeding. At this developmental stage, they have no digestion system as such and their enzymatic production is very limited. To make it possible for larvae to digest nutrients the nutrients have to be in an available and readily digestible form. Natural prey is rich in digestive enzymes. After the larvae has eaten the prey, it is digested by use of its own enzymes. The digesting process results in a degradation or hydrolysis of proteins to amino acids and peptides, and fat is separatedinto fatty acids. After this process the nutrients are available for energy and growth.

So far as we are aware, there is no known commercially-formulated or “artificial” food that may be used as a substitute for live food as starter feed.

In the period while the larvae are emptying their yolk sacs, and are preparing for exogenous feeding, the food supplied to the larvae may consist of live organisms that are produced in different ways. Commonly, this starter feed is based on one or more of the following:
1. Rotifers (Brachionus plicatilis). These small organisms are raised in the laboratory and fed with algae and other nutrients before being used as live prey in the first feeding period for marine juveniles.
2. Artemia. Cysts, the resting stages or “eggs” of this saltwater species, are collected in salt lakes, mainly in the United States of America. In the laboratory the cysts are hatched in water, and used as live prey. Before use, the Artemia has to be enriched by a nutrient solution, making it more suitable as prey. Artemia is mainly acting as a live capsule for the nutrients.
3. Zooplankton. This mixture of natural plankton species can be collected by filtering it off from seawater. The collected plankton is then used as feed.

All the above have some limitations as larval feed. Within the aquaculture industry it is a common opinion that using live prey as the starter feed is severely limiting the cultivation of new aquaculture species. The cultivation of fry from species such as cod and halibut is fluctuating from year to year. This makes it difficult and risky to establish an industrial production from marine aquaculture species, as can be understood from the following.

1. Producing Rotifers is very labour-intensive and expensive. Not only does algae have to be produced as feed for Rotifers but Rotifers are also very small and suitable as prey for the larvae only for a very short period of time.
2. Artemia is not a natural food source for the most commonly-produced aquaculture species. However, owing to the storability of cysts it has become very popular globally as an aquaculture feed. A large part of the Artemia production is used as feed for shellfish, for example prawns. Unfortunately, the global Artemia production is very limited, and this production is not expected to increase much due to the natural sources being restricted geographically to very few areas, mostly located in the United States of America.

Artemia is, from a nutritional point of view, not very suitable as larval feed. To improve the nutritional value it is necessary to enrich Artemia with nutrients, and considerable resources have been devoted to this. It is a common problem in the aquaculture industry that a large proportion of the produced fry is badly developed due to inappropriate nutrition from Artemia. Malpigmentation and other deformities are quite common in marine fry fed with Artemia.

In addition, Artemia is very expensive. Due to a lack of supply the price has been rising dramatically over the past two years. The global Artemia production is less than 3000 metric tons annually, and the aquaculture industry is growing. This increasing demand cannot be met by using Artemia as prey.

3. Zooplankton is a natural prey for most fish species. However, using zooplankton causes much uncertainty in the availability of prey. In addition, this feed source cannot be stored. There is also considerable uncertainty concerning the quality of the zooplankton, for together with the desired high quality prey, unwanted and dangerous species can also be collected. It is well known that pathogenic organisms may cause the outbreak of diseases. It is difficult to establish an industrial production on such an uncertain source.

Many attempts have been made to develop formulated or “artificial” feeds, as a substitute for live prey. Some feed products are successfully partly substituting live prey, but only for a later stage of development, when the larva has, to some degree, been developing its own enzyme production.

Unfortunately, it is technically difficult to produce a dry feed including sufficient amounts of the required hydrolysed proteins in the form of amino acids and peptides. Nutrients leak from the feed particles produced and water-soluble nutrients are to a great extent diluted into the water before the larvae consume the feed.

Dry feed mainly consists of proteins which, without any added enzymes, the fish larvae are unable to digest. Naturally-occurring enzymes in the feed are inactivated owing to heating and drying during the production process. To make proteins available for the larvae the protein must be split into amino acids and peptides, making it possible for the proteins effectively to pass through the intestine walls.

Most experiments with the purpose of developing a formulated feed are based on nutrients in dry powder form, but this has some disadvantages. The small particles forming the powder have a very high surface area/volume ratio compared to larger particle sizes; this results in a very rapid leaking of water-soluble nutrients into the water, which causes pollution and unsuitable water conditions for the larvae. Therefore, essential water-soluble nutrients will not be available for the larvae.

Much effort has been made to solve the problems with nutrient leaking. A common approach to the problem has been to use coatings on the surface of the particles. However, generally speaking, these coatings are not digested, and the nutrient is therefore not available to the larvae.

Larvae need water—they have to “drink”—and another disadvantage of using dried feed is that the larvae have to ingest seawater to compensate for the lack of water in the formulated feed. However, a fish larva has limited capacity for separating salt. The osmotic regulation system of the larva, at this early stage, is not yet completely developed. Larvae have approximately 0.9% salt in their body fluids. Seawater normally consists of 2.5-3.5% salts. This causes a major problem with the osmotic regulation mechanisms, and may be fatal.

It will be seen that what is required is an artificial feed which is: available to the larvae when required; makes nutrients available to the larvae which are easily digestible; does not necessitate the larvae ingesting unwanted quantities of seawater; can be produced in desired particle sizes; and reduces the risk that pathogenic microorganisms are transferred to the fish larvae. Such an artificial feed would have some of the protein in the form of amino acids and peptides, which makes it possible for the larvae to digest nutrients and use it for metabolic activities and growth, contain suitable amounts of water to eliminate osmotic stress, and have a membrane making it possible to have a slow release of nutrient. Any nutrients released into the water before being consumed by the larvae would become dissolved in the water, and would be dissipated by the water flow, resulting in a minimum of pollution. The problem is to produce such a feed—and it is this problem that the invention tackles, by proposing novel methods of making encapsulated material.

According to one aspect of the invention there is provided a method of encapsulating a product to make capsules each comprised of a shell which holds the product and is formed of polymeric material which consists substantially totally of a single polymer, the method comprising:

forming droplets of a liquid mixture of the product and a single prepolymer; and

then exposing the droplets to a polymerising medium for the prepolymer so as to polymerise the outer surfaces of the droplets, thereby forming the shells and thus the desired capsules.

In this way it is possible to make globular particles in the form of capsules each containing an inner core of a product and an outer polymer shell comprised substantially totally of a single polymer holding the product—and according to a second aspect of the invention, there is provided this per se—that is, a capsule comprising an outer shell comprised of polymeric material which consists substantially totally of a single polymer and an inner core consisting of a product.

The product—the material to be encapsulated—is, preferably, in a liquid form, which may include some small solid particles. It can have any desired content, such as food or pharmaceuticals. In the case of food—for example, aquatic larval feed—the liquid can contain nutrients in the form of one or more of water, proteins, peptides, amino acids, fat, fatty acids, minerals, vitamins and possibly enzymes and microbes. In addition, the liquid product is mixed with a suitable prepolymer which forms the outer shells of the capsules. The following description relates for the most part to the encapsulation of product useful as larval fish food.

The nutrient levels of the product can be varied within a wide range of values.

Water content may be varied between 5% and 99%. Preferably, the water content is between 70% and 85%, corresponding to between 30% and 15% of the other aforementioned nutrients. This proportion is the same as in zooplankton that is the fish larvae's natural prey.

Protein content may vary considerably between 1% and 95%, but is advantageously between 10% and 20%. This is the same protein content as in the live prey.

The protein is completely or partially broken down into amino acids and peptides. The degree of splitting or hydrolysis of the protein may vary considerably. The preferable degree of splitting or hydrolysing is between 10% and 70% of the protein. This is a normal level of splitting or hydrolysing for digested proteins for the larvae. A particular advantageous process for producing hydrolysed protein food for aquatic organisms, which process is novel and inventive per se, is described in more detail hereinafter.

Other nutrients may be added to optimise the nutritional value for the larvae. For example, a preferred product consists per 100 KGs feed in dry weight of:—

Vitamin mix: 168.3 g

Mineral mix: 119.5 g

Astaxanthin: 208.5 g

Fish oil: 10000.0 g

Lecithin: 5000.0 g

Vitamins and minerals are essential to maintaining the health of larvae and are therefore added to the food to ensure the larvae have the appropriate amounts in their diet. Astaxanthin is a red colourant, which is useful in attracting larvae to the feed, and is also an antioxidant to prevent the fats and fatty acids becoming rancid. In addition, astaxanthin can be converted to vitamin A by the larvae. The fish oil is an important source of energy and important Omega 3 fatty acids like EPA (eicodapentaenoic acids) and DHA (docosahexaenoic acid) which fatty acids form structural components of the cell membranes. Lecithin is a phospho-lipid and is also very important for the cell membranes and as an emulsifier for the digestion of fat.

The size of the capsules can be adapted to the needs of the organism. For fish larvae a typical particle size is between 0.1 and 5 millimetres in diameter. For other organisms, such as molluscs, the particle size may be significantly smaller.

A preferred range of capsule sizes is:—

less than 0.10 mm in diameter for mollusc species

0.10-0.25 mm in diameter to substitute live prey such as Rotifers which are fed to the larvae of, for example, cod, turbot, seabass, seabream and prawns.

0.25-1.00 mm in diameter to substitute live prey such as Artemia which is fed to the larvae of, for example, Halibut and also at a later stage of development to the larvae mentioned above which feed on Rotifers.

1.00-5.00 mm in diameter to substitute other artificial feed.

The method of producing the capsules involves adding to the liquid nutrient a suitable prepolymer, such as a monomer or an oligomer, for the polymer shell. The liquid nutrient has properties, for example an appropriate pH, making the applied prepolymer soluble. Adding adequate amounts of the prepolymer results in a viscous nutrient liquid. The addition of prepolymer may vary between 0.2 and 10 wt %, but 0.5 to 3.0 wt % is preferable. The preferred prepolymers can be divided into anionic prepolymers and cationic prepolymers. Suitable anionic prepolymers for capsule formation include the prepolymers of alginate, carboxymethylcellulose, xanthin, hyaluronic acid, gellan gum, cellulose sulphate, carragenans, and polyacrylic acid. Preferably the prepolymer is that of alginate. Preferred cationic prepolymers include the prepolymers of chitosan derivates, polyallylamines, quaternised polyamines, polydiallyldimethyl ammonium chloride, polytrimethylammoetylactrylate-co-acrylamid, polymethylene-co-guanidine and polyvinyl amine. Most preferably the prepolymer is that of chitosan.

Chitosan is a natural product which is derived from the polysaccharide chitin by means of chemical treatment. Chitin is found in the outer shells of insects, and some shellfish. Chitosan fibres differ from other fibres in that they possess a positive ion charge, which gives chitosan the ability to bond chemically with negatively charged ions.

Alginate is a natural hydrocolloid polysaccharide extracted from brown seaweed and kelp, and is being used in a wide variety of applications as thickeners, stabilizers and gelling agents.

In the method of the invention, product/prepolymer mixture droplets of appropriate size can be produced either by dripping the liquid with pipettes, by pumping of the liquid through a nozzle to form a spray, or by other adequate techniques. When spraying, the drop size can be varied by adjusting the pressure in the pump, by using different nozzle types, or by varying the viscosity of the liquid. Using a frequency transformer can vary the pressure.

The drops are exposed to a polymerising medium in order to polymerise the outer surface of the droplets. The polymerised shell transforms the droplet into a capsule with an inner liquid core. In order to form capsules with appropriate properties a combination of prepolymers in the product/prepolymer mixture and reaction conditions with the polymerising medium may be used. The polymerising medium can be of any suitable form, such as electromagnetic radiation, an acid, alkali and ions of metals such as calcium, barium and iron.

By using as the polymerising medium a viscous liquid at low pH, a chitosan salt may be used to form the polymer. By using a viscous liquid at higher pH, an alginate salt may be used to form the polymer. Prepolymers with different properties demand a different pH in order to be dissolved. Using chitosan a pH lower than 6.5 is appropriate and using alginates a pH higher than 6.0 is appropriate.

By using a polymerising medium in the form of a liquid at alkaline pH chitosan is polymerised. Conversely, using a liquid polymerising medium at acidic pH and containing metallic ions, and if desired, another polymer like chitosan, causes alginate to polymerise.

Advantageously, the capsules are produced by introducing droplets of the product mixture into the polymerising medium. For example, if the product mixture is a viscous liquid mixture of nutrients and chitosan salt, the droplets are introduced into an alkaline solution. Since the viscosity of the product mixture determines the capsule size, the latter can, to some extent, be set by suitably selecting the former. If a particular marine species requires a small capsule size, the capsules are formed in a “chemical fog” in an atmosphere. It is possible to spray fine droplets of the nutrient-containing solution into an atmosphere so that they remain suspended in that atmosphere. The polymerising medium can on the one hand by a fog or mist; it can be sprayed, by compressed air or other suitable propellants, into the atmosphere where the capsules are formed in the atmosphere. On the other hand, the polymerising medium can be a bath beneath the atmosphere; when droplets condense in the atmosphere to a size where they precipitate out into the bath, the capsules are then actually formed in the bath.

The product mixture—conveniently as a viscous nutrient solution—can be used to form capsules by dripping or spraying it directly into an alkaline polymerising solution. If another prepolymer is used, the viscous solution must be pH adjusted for the polymerisation to occur.

As noted above, the nutrient product mixture may contain hydrolysed protein—protein that has been at least partially broken down into its component peptides and amino acids—and in a third aspect the invention provides a process for preparing such a hydrolysed protein. More specifically, according to this third aspect of the invention, there is provided a method of producing a liquid food for aquatic organisms comprising hydrolysing a proteinaceous raw material to produce a substance comprising a nutrient liquid, and treating the substance to separate the nutrient liquid from any undesired solid particles.

The proteinaceous raw material is, preferably, protein obtained from any fish species—for example, herring, mackerel, sardine, cod, or seith. However other high quality proteins—for example, casein, from milk—can also be used, as can synthetic proteins and amino acids and proteins produced by microorganisms.

The raw material is hydrolysed by use of naturally occurring and/or added enzymes. This process can be under acidic or alkaline conditions. Adding an acid or an alkali alone can also cause the hydroxylation of proteins, but is preferably performed in combination with enzymes. The hydrolysis breaks the protein down into its constituent amino acids and peptides. The aquatic larvae, whose digestive system is not fully developed, can then utilize the nutrient.

If herring and herring by-products are used as the raw material, it is preferably ground before adding acid. Naturally occurring enzymes in the fish aid in the breakdown of the proteins into amino acids and peptides.

After a period of time a turbid and viscous substance is produced comprising a liquid nutrient-containing part and a solid part. The substance is treated to separate the two parts, preferably by using a centrifuge. If desired an additional treatment can be made using ceramic filters, which further purifies the liquid. Using this process a clear nutrient solution is produced without any visible solid particles. The nutrient solution contains proteins, amino acids, peptides, fat, fatty acids, minerals, vitamins, water and acid.

Other nutrients can be added to meet nutritional requirements, as previously mentioned.

In this way it is possible to produce a nutrient-rich liquid food for aquatic organisms and separate out unwanted solid particles from the raw material. The liquid food is particularly suited to the formation of capsules having the liquid food at the core.

As so Ear described the method of the invention comprises forming droplets of a liquid mixture of a product and a single prepolymer and then exposing the droplets to a polymerising medium for the prepolymer so as to polymerise the outer surfaces of the droplets, thereby forming a shell around, and thus encapsulating, each product droplet. By this method there are made capsules each comprised of a shell which holds the product and is formed of polymeric material which consists substantially totally of a single polymer. However, the invention also proposes an alternative method, in which there are first formed capsules that do not contain the desired product, and then these capsules are placed in a product-rich environment such that the product diffuses through the wall of each capsule into the capsule, so providing the desired encapsulated product.

Thus, according to a fourth aspect of the invention, there is provided an alternative method of encapsulating a product to make capsules each comprised of a polymer shell holding the product, the method comprising:

forming shells containing no product by exposing droplets of a prepolymer to a polymerising medium for the prepolymer, so as to polymerise the outer surfaces of the droplets and thus form the shells; and

exposing these shells to an environment containing the product, and causing or allowing the product to diffuse through and into the shells, thus forming the desired capsules.

In this way it is possible to make capsules each comprising an inner core of the product and an outer polymer shell holding the product.

By producing capsules by forming droplets of a prepolymer and exposing the droplets to a polymerising medium, capsules that do not contain the product can be produced. If the product-free capsules are exposed to the product, the product will be caused or allowed to diffuse into the capsules. This process is due to a diffusion gradient between the product and the core of the product-free capsule. The product can be, for example, a liquid food for fish larvae or a pharmaceutical.

In this instance, the polymerising medium can include, as previously mentioned, electromagnetic radiation, an acid, alkali and ions of metals such as calcium, barium and iron, but also an oppositely charged prepolymer.

By using a polymerising medium in the form of a precursor of alginate a precursor of chitosan is polymerised. Conversely, using a polymerising medium in the form of a precursor of chitosan a precursor of alginate is polymerised.

Advantageously, the capsules are formed in baths or in an atmosphere in a similar manner as previously mentioned.

Once formed, the capsules of the invention are most advantageously dried. This is per se a novel and inventive concept and thus according to a fifth aspect of the invention, there is provided a method of treating a capsule comprised of a liquid core and a polymeric shell, comprising drying the capsule, and thereby increasing the density of the capsule shell. It is the density of the capsule shell that is increased.

In this way it is possible to reduce the rate of leakage of the liquid core through the polymeric shell. Therefore, this method has many advantages in producing, for example, food capsules for marine larvae or pharmaceutical capsules.

The liquid core typically contains 75% to 90% water whilst it is technically difficult to measure the water content of the shell. Drying the capsules using, for example, a vacuum evaporator can reduce the water content of the shells and increase the density of the shells and thus the capsules.

According to a sixth aspect of the present invention, there is provided a method comprising providing a capsule having a permeable polymeric shell and a core of liquid food for aquatic organisms having a dry matter content, submerging the capsule in an aquatic environment where the liquid food leaks into the environment via the shell, at least 40% of the dry matter content of the core material remaining in the capsule once the leaking has substantially ceased, and the capsules being consumed by the aquatic organisms.

Owing to this aspect of the invention, aquatic organisms can be supplied with liquid food in capsule form, which capsules have a sufficient nutritive value even after leakage of the liquid food has substantially ceased.

The capsules have a density adapted to the relevant salinity of the seawater into which they are to be submerged. This is important in order to have a very slow sinking rate in seawater and to be available for a period of time for the aquatic organisms.

Seawater salinity is between 2.0% and 3.5% which is a normal salinity for the cultivation of marine fish species. Other aquatic organisms may have different demands. The density of the capsules may be adjusted by drying or varying the concentration of nutrients, minerals and salt.

An outer shell giving a slow release of nutrients allows the liquid food to be available for the aquatic organisms eating the capsules. The time needed to release the entire nutrient varies depending on capsule size and the shell properties. For example, for a capsule diameter of 0.22 mm it takes just 5 to 10 minutes for the protein dry matter content to be reduced to 50%. If the capsule diameter is 1.7 mm a similar reduction of the protein dry matter content takes many hours.

The capsules can be preserved for storage in a variety of ways, including lowering the pH of the feed to below 4.0, freezing or drying. To prevent fat in the feed from becoming rancid, vacuum-packing or inert atmosphere packing can be used. In addition, antioxidants may be added to the feed.

Upon feeding the capsules to organisms such as fish larvae, the nutrient is available and used for energy and growth.

In order that the invention may be clearly and completely disclosed, reference will now be made, by way of illustration only to the following Examples, and to the accompanying drawings in which:—

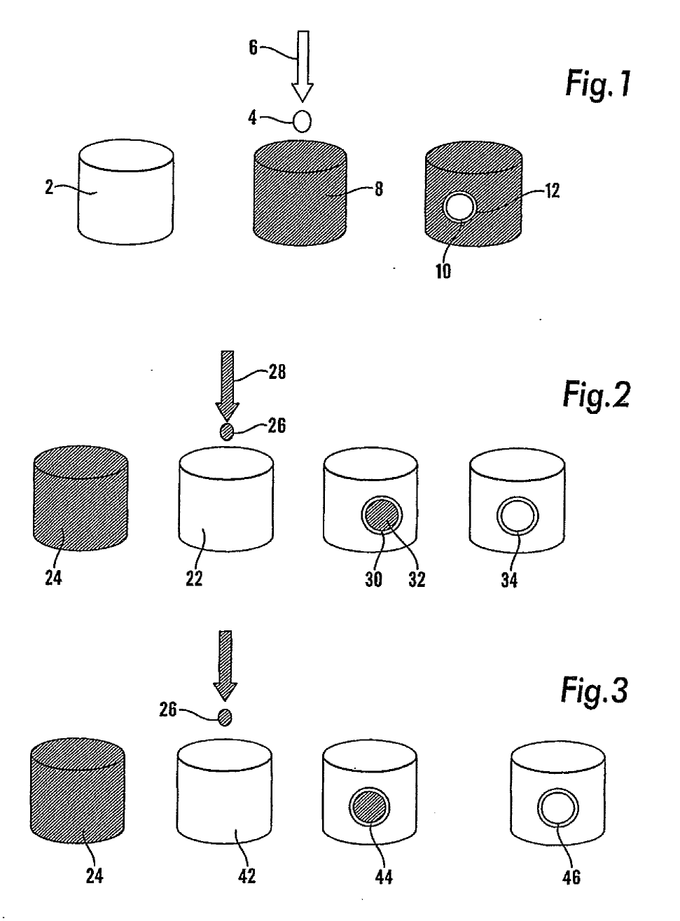

FIG. 1 is a diagram of a first embodiment of a method of producing Capsules,

FIG. 2 is a diagram of a second embodiment of a method of producing the capsules,

FIG. 3 is a diagram similar to FIG. 2 but of a third embodiment,

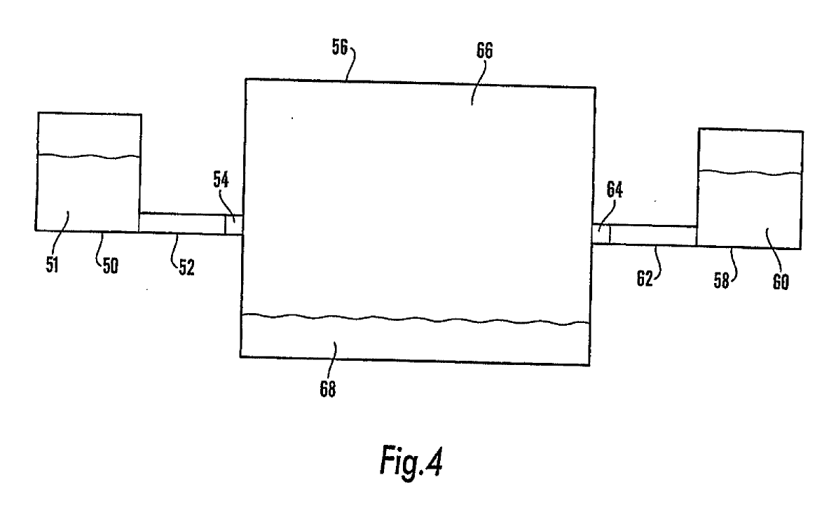

FIG. 4 is a diagram of a fourth embodiment of a method of producing the capsules,

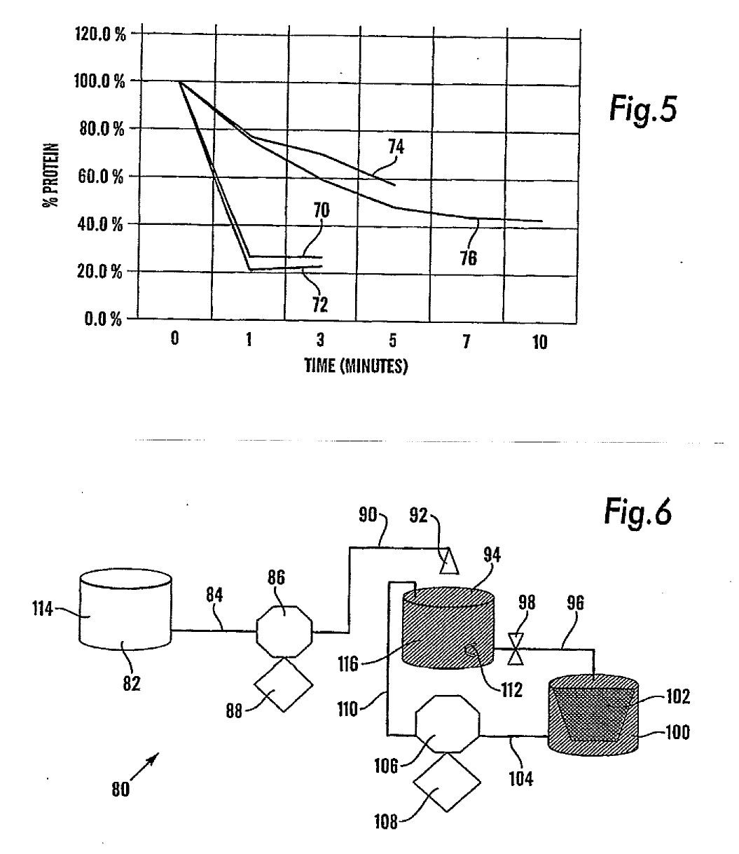

FIG. 5 is a graph showing leakage of protein from four different capsules in seawater over time, and

FIG. 6 is a diagram of a pilot plant for producing the capsules.

### EXAMPLE 1

### Capsules Produced by Dripping Chitosan-Hydrolysate Solution into an Alkaline Solution

### Preliminary Stage

Fresh herring by-products were used as the raw material. They were ground and 2.0% hydrochloric acid and 0.5% acetic acid were added. The resultant substance had a pH of 3.7.

The substance was stirred and heated to a temperature of 40° C. to optimise the hydrolysis process. The naturally occurring enzymes in the herring together with the added acids broke down the proteins into amino acids and peptides. Complete hydrolysis could take from between 2 hours and 5 days. The substance was heated up to a temperature of 90° C. A tricanter centrifuge separated the liquid fraction from solid particles. The liquid contained water, hydrolysed proteins, and minerals occurring naturally in the raw material, together with added acids and small fragments in the form of undissolved proteins and bones.

The liquid fraction was pumped into a cross-flow membrane ceramic filter in order to purify the liquid. A clear, light brown or yellow liquid product called “permeate”, free from visible particles, was formed. This liquid was an acidic hydrolysate at a pH of 4.12.

### Final Stage A

0.5 g of a 1.0% chitosan prepolymer solution (protasan G213 produced by Pronova Biomedical) was added to 50 ml of the hydrolysate liquid during magnetic stirring.

The solution was exposed to a polymerising medium as it was dropped by pipette into a bath of 0.2 Molar sodium hydroxide solution (NaOH).

The drop of liquid containing the chitosan and hydrolysate dissolved and no capsule was formed. The reason for this was that the viscosity of the droplet was too low to keep the droplet shape during the capsule-forming process. The 1% chitosan prepolymer solution was too low to form a capsule.

### Final Stage B

In a second attempt and referring to FIG. 1, 0.5 g of a 2.5% chitosan salt (protasan G213) solution was added to 20 ml of the hydrolysate during stirring to form a chitosan-hydrolysate solution 2.

A droplet 4 of the solution 2 was dropped by a pipette 6 into a bath of 0.2 Molar sodiumhydroxide solution 8.

Immediately, a chemical process formed a shell 10 on the external surface of the droplet 4. The droplet was transformed into a capsule 12 with a solid shell of substantially totally chitosan and a core of liquid nutrients.

The capsules had an average weight of 0.033 g and a diameter of approximately 1.7 mm.

The chitosan salt was soluble in the acidic conditions of the droplet solution. At the interface between the acidic droplet 4 and the alkaline solution 8, chitosan was insoluble and formed the stable polymeric shell 10 around the droplet.

Most zooplanktons have shells containing chitin. This process, as such, was copying nature.

### EXAMPLE 2

### Capsules Produced by Dripping an Alginate Solution into a Chitosan-Hydrolysate Solution

### Preliminary Stage

Referring to FIG. 2, a chitosan-hydrolysate solution 22 was produced by taking a 4% chitosan salt, (protasan C1213) solution and adding it to 50 ml hydrolysate liquid at pH 3.82. The resultant solution 22 was heated and stirred.

A 1 g alginate salt (protanal RF 6650) was dissolved into 100 ml water and stirred during heating. A viscous, clear liquid 24 at pH 6.7 was formed.

### Final Stage A

In a first attempt, a droplet 26 of the solution 24 was dropped into the solution 22 forming weak unstable capsules owing to the pH of the solution 24 being too low.

### Final Stage B

In a second attempt, the pH of the solution 24 was adjusted to 12.5.

The solution 24 was exposed to a polymerising medium by dropping the droplet 26 into the solution 22 by use of a pipette 28.

Stable and strong shells 30 containing no product were immediately formed.

By maintaining the exposure of the shells 30 to the solution 22 some of the solution 22 diffused through the shell and into the core 32 of the capsule. This was caused by the higher osmotic pressure in the solution 22 than in solution 24 which formed the core of the shells 30. After a period of time of exposure in the solution 22, nutrient-rich capsules 34 containing amino acids, peptides and other desirable water-soluble nutrients which were present in the solution 22 were formed.

Producing the capsules 34 by using a solution from positively charged chitosan salt solutions 22 and negatively charged alginate salt solutions 24 formed a stable and good polymer complex shell.

when shells containing no product were put into hydrolysate containing 7.41% nutrients in dry matter, and analysed for dry matter content at differing time intervals, capsules were approaching saturation with hydrolysate after 2 to 3 hours exposure, as shown in Table 1.

TABLE 1

| | | | % of dry |
|---|---|---|---|
| | | | matter of |
| | | | capsule in |
| | | | relation to |
| | | | % dry matter |
| | % Dry matter | Weight of 10 | in |
| | of capsule | capsules (g) | hydrolysate |
| 0 minute | 2.7% | 0.45 g | 36.17% |
| 70 minutes | 6.4% | 0.41 g | 86.23% |
| 120 minutes | 7.2% | 0.43 g | 97.71% |
| 295 minutes | 7.6% | 0.45 g | 102.56% |

When the shells containing no product were put into hydrolysate containing 18% nutrients in dry matter, and analysed for dry matter content at differing time intervals, capsules smaller than those in Table 1 were approaching saturation after 1 to 5 hours exposure, as shown in Table 2.

TABLE 2

| | | | % of dry |
|---|---|---|---|
| | | | matter of |
| | | | capsule in |
| | | | relation to |
| | | | % dry matter |
| | % Dry matter | Weight of 10 | in |
| | of capsule | capsules (g) | hydrolysate |
| 0 minute | 2.7% | 0.35 g | 14.89% |
| 5 minutes | 9.5% | 0.35 g | 52.61% |
| 70 minutes | 11.7% | 0.38 g | 64.83% |
| 120 minutes | 16.1% | 0.38 g | 89.17% |
| 290 minutes | 17.1% | 0.34 g | 94.78% |

### EXAMPLE 3

### Capsules Produced by Dripping Alginate Solution into a Hydrolysate Solution

Referring to FIG. 3, nutrient-rich capsules were formed in a similar way to Example 2 above, except that no chitosan salt was mixed with the hydrolysate solution 42. The hydrolysate was acidic and contained dilute metallic ions such as calcium from the fish bones which formed the polymerising medium. Exposing the droplet 26 of the solution 24 to the solution 42 caused the polymer complex to be formed on the external surface of the droplet 26, forming shells 44 containing no hydrolysate solution 42.

By way of the diffusion process described with reference to Example 2, nutrient-rich capsules 46 were formed.

### EXAMPLE 4

### Production of Capsules by Use of Chemical Fog

To produce very small capsules required by certain species of marine larvae it is necessary to produce capsules with a core liquid with a relatively low viscosity. The Final Stage A in Example 1 described the problems in using too low a viscosity if the method were to be by dripping a core liquid into a bath. Referring to FIG. 4, a bath 50 contained a 0.5% alginate solution 51. The bath 50 was a 50 L container at atmospheric pressure. The solution 51 was pumped under pressure through a pipe 52 and a nozzle 54 to a tank 56. In addition, a bath 58 contained a 1% Calcium chloride and 0.6% acetic acid in water solution 60. The bath 58 was a 60 L container at 6 bar air-pressure and was similarly connected to the tank 56 via a pipe 62 and a nozzle 64. The solutions 51 and 60 were forced via the tubes 52 and 62 and the nozzles 54 and 64 into the tank 56 as extremely small, fog-like droplets. The tank 56 was a 5000 L container at atmospheric pressure in which the droplets of the solution 60 met the relatively larger droplets from the alginate solution 51 and a polymerisation reaction took place in the atmosphere 66 in the tank 56. Shells comprising a core of the solution 51 were thus formed and fell into a bath of a hydrolysate solution 68. By way of the diffusion process described with reference to Example 2 above, very small nutrient-rich capsules of 100 microns or less in diameter were formed. Furthermore, reducing or eliminating the need for a viscous core material enabled the concentration of the prepolymer to be reduced and a wider range of prepolymers can be used because it is not essential to form a viscous liquid. Moreover, at high viscosity the reaction time for capsule formation is slow since the mass transfer rate is reduced. The method of using a “fog” improves the mass transfer rate and thereby the potential for producing a more dense shell. This may be of the utmost importance for some applications; as feed because leaking of nutrient is a major problem in the art of producing small particle larvae artificial feed, and for some medical uses. In addition a high yield of capsules is obtained using this method of production.

The methods of capsule production shown in FIGS. 1, 2 and 3 can also be carried out in such a “fog” atmosphere.

### Test Results

### Leaching of Nutrients

Referring to FIG. 5, an important property for the capsules as feed for marine species is the speed of leaching of nutrient into the seawater once they are submerged. There must be a limited degree of leaching as an attractant; however, if the leaching rate is high, the amount of water-soluble nutrient left in the capsules will be too low for the larvae's needs. This is a major problem in using dry feed. The density of the capsule shells can be increased by vacuum drying the capsules, which significantly reduces the rate of leakage.

The line 70 represents the rate of leaching of the protein percentage over 3 minutes from capsules the shells of which have not been vacuum dried. Once submerged in seawater at time 0, there is an extremely rapid leakage of protein from 100% to around 20-30% in 1 minute, with no significant change thereafter up to 3 minutes. A similar rapid leakage occurs for line 72 which represents capsules which, instead of being vacuum dried to alter the shell characteristics, have had a coating applied comprising 10% of a particular fatty acid, DF20-22 (Produced by Olean Scandinavia AS). The line 74 represents capsules which have a coating comprised of 10% stearol (produced by WWR International) a fatty acid, and have been vacuum dried. FIG. 5 clearly shows that there is a significant reduction in the leakage of protein compared to lines 70 and 72; 100% at time 0 to around 70% remaining at 3 minutes. The line 76 represents the leakage of protein from capsules that have been vacuum dried only. The leakage rate is significantly reduced and closely follows that of line 74 having 100% at time 0 and around 60% at 3 minutes. This shows the little additional contribution made by the Stearol coating on the capsules represented by line 74. Thus, vacuum drying has a significant effect on the rate of leakage of the nutrients from the capsules.

In relation to leakage over longer periods of time, Table 3 shows leakage from capsules produced according to Example 2 which are submerged in seawater at 3.5% salinity and at different time intervals, collecting 10 capsules from the seawater, drying them in blotting paper to remove surface water, and analysing them for dry matter content in an HR 73 Halogen moisture analyser.

TABLE 3

| | % Dry-matter of | % of original |
|---|---|---|
| | nutrient in | concentration of |
| | capsules | nutrient |
| 0 minute | 18.0% | 100.0% |
| 75 minutes | 9.1% | 50.6% |
| 120 minutes | 4.8% | 26.7% |

Table 3 shows that after 75 minutes submerged in seawater, capsules still contained around 50% of the original nutrient content. The leaching was dependent on the capsule surface area to volume ratio, and, thus, smaller sized capsules had relatively higher leaching than larger capsules.

### Sink Rate of Capsules

It is also important that the capsules do not sink too fast, in order to be available for the larvae for a long period of time. It is a common problem with dry feed that the sinking rate is too high, and the feed is only available for the pelagic larvae for a very limited period of time.

Capsules graded with a nylon sheet with a 120 micron mesh size were tested to find the sinking rate at different saltwater salinities. Glass spheres of a known density were used to control the water salinity level. A range of salinities are made by mixing saltwater and freshwater in different quantities. Capsules are put in a water column for the sinking rate to be measured. Table 4 shows the sinking rates of capsules with an average particle size of 137 microns in diameter.

TABLE 4

| | Max. sink | Min. sink | Average sink |
|---|---|---|---|
| | rate | rate | rate |
| Salinity | (cm/min) | (cm/min) | (cm/min) |
| 3.10% | 12.5 | 8.2 | 10.0 |
| 3.48% | 10.0 | 4.6 | 7.3 |
| 3.51% | 8.0 | 4.0 | 6.0 |
| 3.66% | — | — | 0.0 |
| | | | (neutral) |

The results show adequate sinking rates for the feed to be available for sufficient periods of time. At a salinity of 3.66% the capsules had substantially the same density as the salt water and spread in the whole water column for a long period of time.

### Feeding Incidence

Table 5 shows values for the feeding incidence of 5000 3-day-old cod larvae placed in each of two containers with a water volume of SOL with automatic feeding every 10 minutes from 09:00-22:00 hours. Each feeding delivered 0.33 ml of identical feed to each container. 1 ml of feed contained 23,000 capsules. By extracting 12 larvae from one of the containers after 1 hour of feeding the number of capsules eaten could be examined under a microscope. After 2 hours 13 larvae extracted could be examined in the same way.

TABLE 5

| | No. of | | No. of |
|---|---|---|---|
| No. of | capsules | No. of | capsules |
| larvae after | eaten after | larvae after | eaten after |
| 1 hour | 1 hour | 2 hours | 2 hours |
| 2 | 1 | 2 | 1 |
| 2 | 2 | 2 | 2 |
| 1 | 3 | 4 | 6 |
| 1 | 4 | 2 | 7 |
| 1 | 6 | 1 | 8 |
| 2 | 10 | 1 | 10 |
| 1 | 13 | 1 | 11 |
| 1 | 14 | | |
| 1 | 18 | | |
| Total | Total No. of | Total | Total No. of |
| larvae: 12 | Capsules | larvae: 13 | Capsules: |
| | 84 | | 73 |
| | Average No. | | Average No. |
| | of Capsules | | of Capsules |
| | per larvae | | per larvae |
| | 7.0 | | 5.6 |

After 1 to 2 hours of feeding, all the examined larvae had eaten between 1 and 18 particles each. This shows an acceptable palatability and sinking rate of the capsules.

### Growth of Larvae

Table 6 shows growth rates of cod larvae (Gadhus morhua) over a period of 51 days. Three groups of 1500 larvae were each put in SOL recirculating tanks 4 days after hatching. Two of the groups consisted of larvae fed initially on Rotifers from the fourth day after hatching and subsequently on capsules after either 7 or 14 days post hatching and the third group was a control group which was fed on Rotifers from day 4 to day 21 post hatching and thereafter on artemia. Samples of the larvae were taken after 26, 43 and 51 days after hatching. The larvae were dried in a vacumm/freezedrier and the dry weight of the larvae measured.

TABLE 6

| | | Average dry | Average dry |
|---|---|---|---|
| | | weight of a | weight of a |
| | | single larva | single larva |
| | Average dry | in Control | in Control |
| | weight of a | Group fed | Group fed |
| | single larva | Capsules | Capsules |
| | in Control | after 7 days | after 14 |
| Day | Group (mg) | (mg) | days (mg) |
| 26 | 0.376 | 0.344 | 0.344 |
| 43 | 2.50 | 1.969 | 2.912 |
| 51 | 5.568 | 5.847 | 4.897 |

The results show that the growth of the larvae is approximately the same for the capsule-fed larvae as for the control group fed on live prey only.

### Mass Production of Capsules

In order to use capsules as feed for a wide range of aquatic larvae it is possible to produce capsules of a variety of sizes. Appropriate capsule sizes depend on the age of the organism and the species to which the capsules are to be fed.

Referring to FIG. 6, a pilot plant 80 suitable for the mass production of capsules of a variety of sizes comprises a tank 82 connected via a tube 84 to an inlet of a high-pressure pump 86. The pumping pressure of the pump 86 can be adjusted with a frequency transformer 88. From the outlet of the pump 86 there is a tube 90 terminating in a nozzle 92. Below the nozzle 92 there is a second tank 94 connected via an outlet pipe 96 and a valve 98 to the top end of a third tank 100 containing a filter 102. The tank 94 contains a stirrer 112. An outlet pipe 104 leads from the lower end of the tank 100 to the inlet of a second pump 106. A second frequency transformer 108 connected to the pump 106 can be adjusted to regulate the pumping capacity of the pump 106. The outlet of the pump 106 is connected to the upper end of the tank 94 via a pipe 110.

In using the pilot plant 80 to produce capsules as described in Example 2, the pumping pressure of the pump 86 is adjusted to an appropriate level for the desired capsule size to be produced by adjusting the frequency transformer 88. An alginate solution 114 contained in the tank 82 is pumped via the pipe 84, the pump 86 and the pipe 90 to the nozzle 92 which creates droplets of an appropriate size. The droplets formed fall into the tank 94 which contains a chitosan-hydrolysate solution 116 stirred by the stirrer 112. Shells containing none of the solution 116 are formed in the solution 116. The shells containing none of the solution 116 are left in the solution 116 in the tank 94 so that the solution 116 can diffuse into the shells, thus forming the capsules, which collect at the bottom of the tank 94. When the valve 98 is opened, a mixture of capsules and the solution 116 flows along the pipe 96 and into the top end of the tank 100. The capsules are separated from the solution 116 by the filter 102. The solution 116 is pumped back to the tank 94 by using the pump 106.

The plant 80 enables an efficient production of capsules of different sizes.

Capsule sizes produced by the pilot plant 80 can be adjusted in the following three different ways, or combinations of them:—

1. Adjusting the pumping pressure of the pump 86 using the frequency transformer 88.

2. Changing the type of nozzle 92.

3. Adjusting the viscosity in the alginate solution 114 in the tank 82.

Capsules examined under a microscope had a size variation of between 0.17 mm and 0.51 mm in diameter for capsules produced at a pump frequency of the pump 86 of 6.5 hz, and between 0.22 mm and 0.37 mm for capsules produced at a pump frequency of the pump 86 of 10.1 hz.

1. A method of feeding aquatic organisms, comprising providing a plurality of microcapsules having an outermost permeable polymeric shell of chitosan or alginate and an inner core of liquid food for the aquatic organism and introducing the microcapsules into an aquatic environment where they are available to be consumed by the organism, wherein:
a. the outermost shells of the microcapsules consist of a single polymer, and the microcapsules do not comprise an inner capsule,
b. the liquid food has a dry matter content comprising water-soluble, hydrolyzed proteins, peptides and amino acids,
c. the microcapsules are arranged to leak the liquid food into the aquatic environment through the shell such that at least 40% of the dry matter content remains in the capsules once the leakage has substantially ceased.

2. A method according to claim 1, wherein the diameter of the capsules is less than 0.10 mm.

3. A method according to claim 1, wherein the diameter of the capsules is from 0.1-5 mm.

4. A method according to claim 1, wherein the diameter of the capsules is from 0.1-0.25 mm.

5. A method according to claim 1, wherein the diameter of the capsules is from 0.25-1 mm.

6. A method according to claim 1, wherein the capsules are dried.

7. A method according to claim 6, wherein the capsules are dried by a vacuum evaporator.

8. A method according to claim 6, wherein the capsules are arranged such that the time required for leakage of 50% of the dry matter content is from 5 minutes to several hours.

9. A method according to claim 8, wherein the capsules are arranged such that the time required for leakage of 50% of the dry matter content is from 5 minutes to 10 minutes.

10. A method according to claim 6, wherein the capsules arranged to sink at a predetermined rate such that the capsules are available to the aquatic organism for a sufficient time to be consumed.

11. A method according to claim 10, whereby the rate of sinking is controlled by adapting the density of the capsules to the salinity of the aquatic environment.

12. A method according to claim 11, whereby the sinking rate is from 12.5 cm/minute or less.

13. A method according to claim 1, wherein the liquid food further comprises one or more supplements, chosen from the group consisting of vitamins, minerals, fish oil, lecithin and astaxanthin.

14. A method according to claim 1, wherein the capsules are made by exposing a first fog comprising droplets of a single prepolymer to a second fog comprising droplets of a polymerizing medium in an atmosphere, whereby, when droplets of the respective fogs make contact with one another a polymerization reaction occurs forming microcapsules having a polymer shell.

15. A method according to claim 14, wherein the droplets of the first fog further comprise the liquid nutrient.

16. A method according to claim 14, wherein the droplets of the first fog consist solely of the single polymer, and wherein, after the microcapsules are formed, allowing the microcapsules to fall into a bath comprising a hydrolysate solution, and allowing the hydrolysate to enter into the microcapsules by diffusion.

17. A method according to any one of claims 1-16, wherein the outer shell consists of alginate.

18. A method a of producing a microencapsulated feed for an aquatic organism, comprising
a. Providing a first solution consisting of a chitosan or alginate prepolymer
b. Providing a second solution comprising a polymerizing medium
c. Exposing a fog of droplets of the first solution to a fog of droplets from the second solution in an atmosphere, whereby a polymerization reaction occurs upon contact of the respective droplets, thus forming microcapsules having a an outer shell consisting of a single polymer,
d. Allowing the microcapsules to fall into a bath comprising water-soluble, hydrolyzed proteins, whereby hydrolyzed proteins, amino acids and peptides are allowed to diffuse into the core of the microcapsules, said core thereby comprising a liquid food having a dry matter content,
e. Drying the microcapsules so as to regulate the density of the microcapsules, the density being chosen such that in the event the capsules are introduced into an aquatic environment the capsules will leak the liquid food into the aquatic environment through the shell such that at least 40% of the dry matter content remains in the capsules once the leakage has substantially ceased.

19. A method a of producing a microencapsulated feed for an aquatic organism, comprising
a. Providing a first solution comprising a liquid nutrient and a single prepolymer of either chitosan or alginate
b. Providing a second solution comprising a polymerizing medium
c. Exposing a fog of droplets of the first solution to a fog of droplets from the second solution in an atmosphere, whereby a polymerization reaction occurs upon contact of the respective droplets, thus forming microcapsules having a an outer shell consisting of a single polymer, and an inner core of liquid nutrient
d. Drying the microcapsules so as to regulate the density of the microcapsules, the density being chosen such that in the event the capsules are introduced into an aquatic environment the capsules will leak the liquid food into the aquatic environment through the shell such that at least 40% of the dry matter content remains in the capsules once the leakage has substantially ceased.

20.
